(19) United States
(12) Patent Application Publication
(10) Pub. No.: US 2004/0129665 A1
(43) Pub. Date: Jul. 8, 2004

(54) Figurines with container cap stand & merchandising method

(76) Inventor: Joyce E. Cavan, Oak Park, CA (US)

Correspondence Address: JOHN J. CONNORS, Suite 220, 1600 DOVE ST., NEWPORT BEACH, CA, 92660, US

(21) Appl. No.: 10/338,308

(22) Filed: Jan. 8, 2003

(51) Int. Cl. B65D 51/00; A63H 3/00; G09F 3/00

(52) U.S. Cl. 215/228; 206/217; 40/307; 40/311; 446/74

(57) ABSTRACT

A merchandising method employs containers and a figurine that is one of a series of different figurines all having a common theme. Individual containers holding the same product enable the product to be removed from the container through a port therein. Covering the port of each individual container is a removable cap with a figurine attached to the cap. The cap serves as a stand for the figurine upon removal of the cap. A plurality of the containers with different figurines attached to the caps thereof are distributed, each figurine conforming to the common theme.

### INCORPORATION BY REFERENCE

Applicants incorporates herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

It is conventional to merchandise products using celebrities who endorse the product. The fans of these celebrities are motivated to buy the product because of this endorsement. It would be desirable to closely associate the product, or at least the container for the product, at the point of sale with the celebrity, or other factors that may motivate one to purchase the product.

### SUMMARY OF INVENTION

This invention, with its several desirable features, is defined in the CLAIMS that follow. After reading the following section entitled “DETAILED DESCRIPTION OF SOME EMBODIMENTS OF THIS INVENTION,” one skilled in the art will understand the benefits this invention provides. These benefits include, but are not limited to: producing a greater demand for a product because a desirable bonus item is provided, and motivating a purchaser to repeat purchases in order to have a collection of a series of related bonus items.

Without limiting the scope of this invention as expressed by the claims that follow, some, but not all, of its features are:

One, this invention comprises the combination of a container and a figurine. The container includes a removable cap comprising a body having a base and a top. The figurine may be fixedly attached to the top.

Two, the container may hold a variety of products, for example, soap such as shampoo and bath gel; toothpaste; a foodstuff such as candy and jelly or jam; deodorant; and body lotion.

Three, The cap may have different shapes, for example, it may have a substantially cylindrical configuration, or a substantially conical configuration, or a substantially elliptical configuration, or a substantially rectangular configuration.

Four, the base includes an underside that is adapted to rest on a horizontal surface upon removal of the cap from the container. This enables the cap to serve as a stand for the figurine with the underside of the base contacting the horizontal surface and the figurine supported in a substantially upright orientation by the cap.

Five, top may include a cover member that is connected by a hinge member to the body of the cap. This cover member has a closed position that covers an opening in the body of cap and an open position that allows the contents of the container to flow through said opening. The figurine has a bottom that is attached to an exterior surface of the cover member.

These features are not listed in any rank order nor is this list intended to be exhaustive.

This invention also includes a merchandising method utilizing the container and figurine combination discussed above. In accordance with one embodiment of this method, a number of individual containers holding the same product are sold. The container has port therein for removal of the product. The port of each individual container is covered with a removable cap with a figurine attached to the cap. The cap serves as a stand for the figurine upon removal of the cap. The figurine is one of a series of different figurines all having a common theme.

A distributor sells these containers and a purchaser (the ultimate user of the product) detaches the cap and partially or completely removes the product. If only a portion of the product is removed from the container, the cap is reattached. When substantially all the product of the container has been removed from the container, the container may be discarded and the cap with the attached figurine is saved. The figurine is one of a series of figurines all having a common theme. A plurality of the containers are sold with different figurines, but each figurine conforms to the common theme. Thus, the purchaser by buying a number of containers, each with a different figurine, is able to build a collection of the figurines with the common theme, each having an individual stand that is the cap of the container. A variety of common themes may be employed. For example, the common theme may be related cartoon characters or animals or plants or athletes or entertainers.

### DESCRIPTION OF DRAWINGS

Some embodiments of this invention, illustrating all its features, will now be discussed in detail. These embodiments depict the novel and non-obvious figurine and container combination and merchandising method of this invention as shown in the accompanying drawings, which are for illustrative purposes only. These drawings includes the following figures (Figs.), with like numerals indicating like parts:

FIG. 1A is a perspective view of an embodiment of a container and figurine combination of this invention. The figurine shown in FIG. 1A, namely, a giraffe, is one of a series of figurines that are related, namely, figurines that are replicas of wild animals, wherein:

FIG. 1B is a perspective view of an embodiment of a container and figurine combination of this invention where the figurine is an elephant;

FIG. 1C is a perspective view of an embodiment of a container and figurine combination of this invention where the figurine is a zebra;

FIG. 1D is a perspective view of an embodiment of a container and figurine combination of this invention where the figurine is a lion.

FIG. 2 is a fragmentary perspective view of the embodiment of this invention depicted in FIG. 1A showing a cap for the container with a top having a cover member that is connected by a hinge member to the body of the cap.

FIG. 2A is a cross-sectional view taken along line 2A-2A of FIG. 2.

FIG. 2B is a side elevational view, partially in cross-section, of the cap of the container shown in FIG. 1A removed and resting on a planar horizontal surface.

FIG. 3 is a perspective view of an embodiment this invention showing a figurine of a prehistoric animal mounted to a cylindrical configured cap for a container.

FIG. 4 is a perspective view of an embodiment this invention showing a figurine of an eagle mounted to a conical configured cap for a container.

FIG. 5 is a perspective view of an embodiment this invention showing a figurine of a kitty cartoon character mounted to an elliptical configured cap for a container.

FIG. 6 is a perspective view of an embodiment this invention showing a figurine of a plant mounted to a rectangular configured cap for a container.

### DETAILED DESCRIPTION OF SOME EMBODIMENTS OF THIS INVENTION

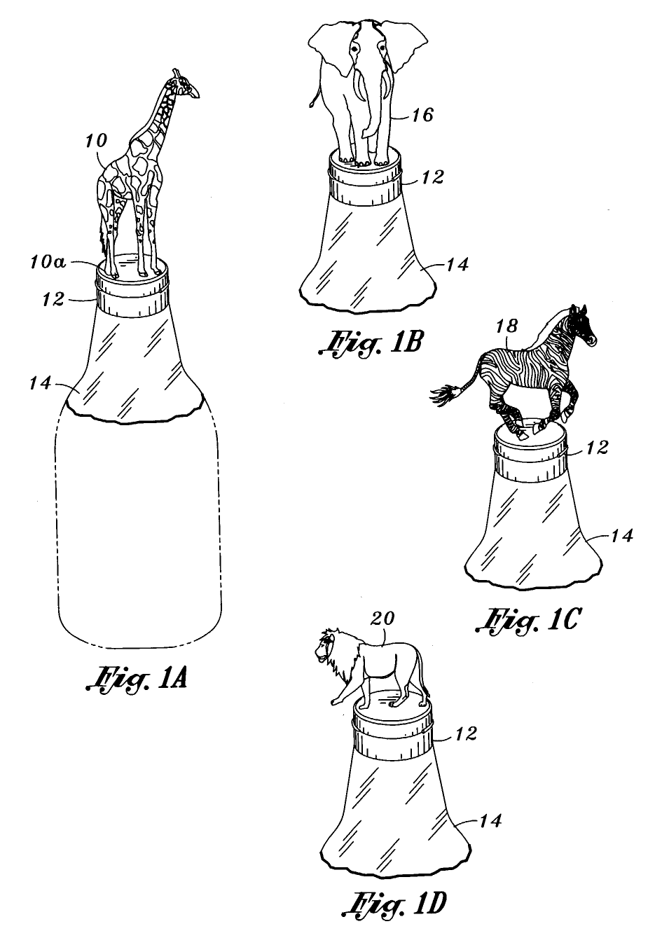

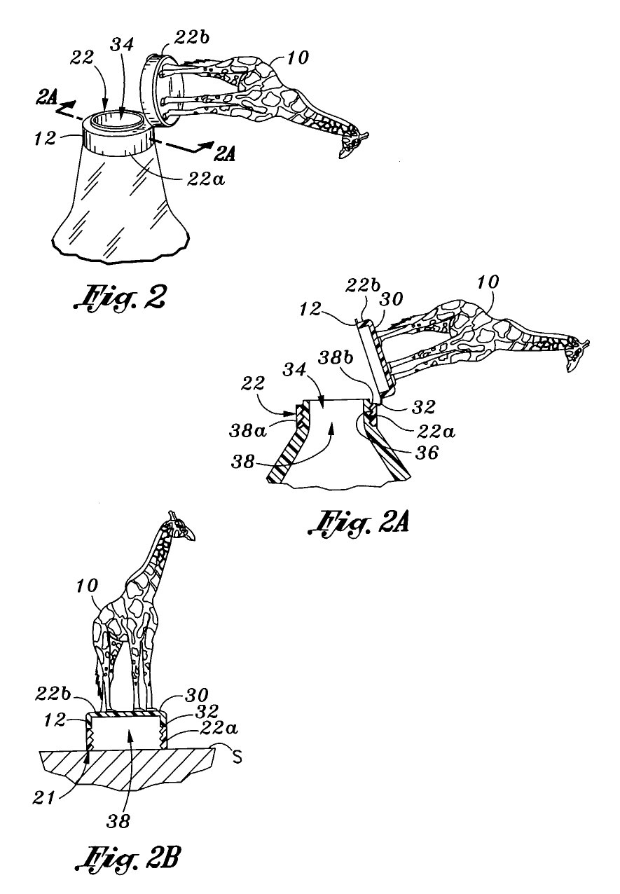

As shown in FIG. 1, this invention includes a figurine 10 attached to a removable cap 12 for a container 14 holding the product being merchandised. Examples of products that may be merchandised according to this invention include, but are not limited to, soap typically a liquid or gel, toothpaste, candy or other foodstuffs, lotion, deodorant, etc. As will be understood upon reading the subsequent disclosure, the figurine employed is one of a series of figurines all having a common theme. For example, the common theme may be (a) related cartoon characters such as for example the Disney® characters Mickey Mouse, Minnie Mouse, Donald Duck, Goofy, Pluto etc., (b) animals both living and prehistoric, (c) plants such as flowers, (d) celebrities such as athletes and entertainers (e) characters from movies such as Star Wars. As illustrated in FIGS. 1A through 1D, the giraffe figurine 10 is one of a series of wild animal figurines, where in FIG. 1B an elephant figurine 16 is mounted to the cap 12, in FIG. 1C a zebra figurine 18 is mounted to the cap 12, and in FIG. 1D a lion figurine 16 is mounted to the cap 12.

As best depicted in FIG. 2A, the cap 12 in this embodiment comprises a body 22 having a base 22a and a top 22b, with the figurine 10 being attached to exterior of the top. In one embodiment, the figurine 10 is fixedly attached to the cap 12 so that it cannot be removed from the cap without damage. The base 22a includes an underside 21 that is level so that the base is adapted to rest on a planar, horizontal surface S upon removal of the cap 12 from the container 14 as shown in FIG. 2B. Consequently, the cap 12 serves as a stand for the figurine 10 with the underside 21 of the base 22a contacting the horizontal surface S and the figurine supported in an upright, substantially vertical orientation by the cap. Typically, the figurine 10 has a bottom 10a that is fixedly attached to the top of the cap, for example, by bonding with an adhesive or the figurine and cap may be a unitary structure formed by conventional injection molding techniques.

As best shown in FIG. 2A, the top 22b of the cap 12 may include a cover member 30 that is connected by a hinge member 32 to the body 22a of the cap. The bottom of the figurine 10 is attached to an exterior surface of the cover member 30. In the embodiment illustrated in FIGS. 1A and 2, the cover member 30 has a closed position (FIG. 1A) that covers an opening 34 in the body 22 of cap 12 and an open position (FIG. 2) that allows the contents of the container 14 to flow through the opening.

As best depicted in FIG. 2A, the container 14 includes an outwardly projecting open threaded port 36 through which the contents, i.e. the product, in the container may be removed. The removable cap 12 that may be used with this threaded port 36 comprises a substantially cylindrical body 22. The underside 21 of the base 22a has a cavity 38 therein extending into the body 22 of the cap 12. This cavity 38 may be formed by a wall 38a with internal threads 38b, enabling the cap 12 to be attached and detached to the threaded port 36. There are no external elements on the underside 21 of the base 22a that would tilt the figurine 10 when the underside is being support on the substantially planar horizontal surface S as depicted in FIG. 2B Thus, the underside 21 rests on the planar horizontal surface S substantially flush with this planar horizontal surface so that the figurine 10 is supported in an upright, substantially vertical orientation.

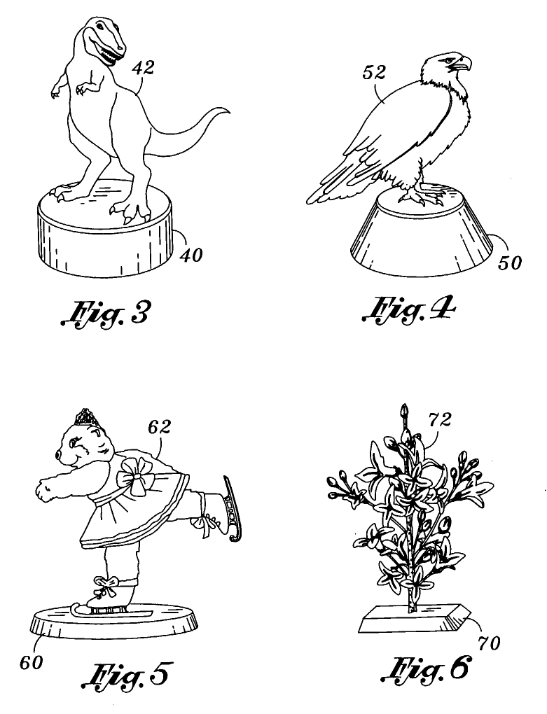

As depicted in FIGS. 3 through 6, a cap may be used that has a different configuration than cylindrical. FIG. 3 shows a cap 40 with a figurine 42 of a prehistoric animal mounted to the cap's top, exterior surface. This cap 40 has a cylindrical configuration like the cap 12. The cap used in this invention may, however, have different configurations. For example: FIG. 4 shows a conical configured cap 50 with a figurine 52 of an eagle mounted to the cap's top, exterior surface. FIG. 5 shows an elliptical configured cap 60 with a figurine 62 of a cartoon character mounted to the cap's top, exterior surface. FIG. 6 shows a rectangular configured cap 70 with a figurine 72 of a cartoon character mounted to the cap's top, exterior surface. The bottoms of the figurines 42, 52, 62, and 72 are each attached to an exterior surface of the caps 40, 50, 60 and 70, respectively. Each of these caps may have a top that is solid and not hinged, in contrast to the figurine shown in FIGS. 1A and 2.

This invention also includes a merchandising method wherein individual containers 14 such as depicted in FIGS. 1A through 1D are provided each holding the same product. The product is adapted to be removed from the container 14 through the opening 34 in the threaded port 36. Covering the port 36 of each individual container 14 is the removable cap 12 with an individual figurine as shown in FIGS. 1A through 1D attached thereto. As discussed above, the cap 12 serves as a stand for the figurine 10, 16, 18, or 20, as the case may be, upon removal. The individual figurine is, however, one of a series of different figurines 10, 16, 18, and 20, all having a common theme. In this example, all the figurines 10, 16, 18, and 20 are wild animals. A plurality of these containers 14 with different figurines attached to the caps 12 thereof are distributed, i.e. sold, each of these with different figurines from the series carrying the different figurines that each individually conform to the common theme. The purchaser or user detaches the cap 12 and typically partially removes a portion of the contents and thereafter reattaches the cap. The user periodically repeats this step until substantially all the product has been removed from the container 14 and then discards the container and saves the cap 12 with the attached figurine. Although the entire contents of the container 14 may be removed at once, typically the product being merchandised in the container is consumed periodically over an extended period of time.

Children will be especially attracted to products merchandised according to this invention when the figurines represent their favorite themes. Moreover, they will be encouraged to use the product so that they will be able to collect the figurine with its associated cap serving as a stand. For example, a child may have an interest in the Star War characters and toothpaste sold in tubes with caps carrying figurines of the different Star War characters. When the child has consciously brushed his or her teeth using up the contents of one toothpaste tube with a cap carrying a figurine of the character R2-D2, then a second tube of the same toothpaste product as the first tube is purchased with a cap carrying a figurine of the character C-3PO. Thus, the child may collect figurines of his or her favorite Star War characters and simultaneously develop the good habit of daily brushing his or her teeth.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. In combination, a container and a figurine,
said container including a removable cap comprising a body having a base and a top,
said figurine being attached to the top,
said base including an underside that is adapted to rest on a horizontal surface upon removal of the cap from the container, enabling the cap to serve as a stand for the figurine with the underside of the base contacting the horizontal surface and the figurine supported in a substantially upright orientation by the cap.

2. The combination of claim 1 where the figurine has a bottom that is attached to the top of the cap.

3. The combination of claim 1 where the top includes a cover member that is connected by a hinge member to the body of the cap, said cover member having a closed position that covers an opening in the body of cap and an open position that allows the contents of the container to flow through said opening.

4. The combination of claim 3 where the figurine has a bottom that is attached to an exterior surface of the cover member.

5. The combination of claim 1 where the container holds soap.

6. The combination of claim 1 where the container holds toothpaste.

7. The combination of claim 1 where the container holds foodstuff.

8. The combination of claim 1 where the container holds deodorant.

9. The combination of claim 1 where the container holds body lotion.

10. The combination of claim 1 where the cap has a substantially cylindrical configuration.

11. The combination of claim 1 where the cap has a substantially conical configuration.

12. The combination of claim 1 where the cap has a substantially elliptical configuration.

13. The combination of claim 1 where the cap has a substantially rectangular configuration.

14. In combination,
a container and a figurine having a bottom,
said container including an outwardly projecting open threaded port through which the contents of the container may be removed and a removable cap attached to the threaded port,
said cap comprising a body having a top to which the bottom of the figurine is fixedly attached and a base including an underside having a cavity therein extending into the body of the cap, said cavity having a wall with internal threads enabling said cap to be attached and detached to the threaded port,
said underside being adapted to rest on a planar horizontal surface upon removal of the cap from the container, enabling the cap to serve as a stand for the figurine with the underside of the base contacting the planar horizontal surface and the figurine supported in an upright, substantially vertical orientation by the cap.

15. The combination of claim 14 where the top includes a cover member that is connected by a hinge member to the body of the cap, said cover member having a closed position that covers an opening in the body of cap and an open position that allows the contents of the container to flow through said port and out said opening.

16. The combination of claim 15 where the bottom of the figurine is fixedly attached to an exterior surface of the cover member.

17. An article of manufacture comprising
a figurine having a bottom, and
a stand for the figurine comprising a cap for a container that is adapted to be attached and detached to a port of the container,
said cap comprising a body having a top to which the bottom of the figurine is fixedly attached and a base including an underside,
said underside being adapted to rest on a horizontal surface, enabling the cap to serve as the stand for the figurine with the underside of the base contacting the horizontal surface and the figurine supported in an upright orientation by the cap.

18. The article of manufacture of claim 17 where the underside of the cap has a cavity therein extending into the body of the cap, said cavity having a wall with internal threads enabling said cap to be attached and detached to a threaded port of the container.

19. The article of manufacture of claim 17 where the top includes a cover member that is connected by a hinge member to the body of the cap, said cover member having a closed position that covers an opening in the body of cap and an open position that allows the contents of the container to flow out said opening.

20. A merchandising method comprising
(a) selling a container holding a product that is removed from the container through a port therein, said port being covered by a removable cap with a figurine attached to the cap, said cap serving as a stand for the figurine,
(b) detaching the cap and partially removing a portion of the product and thereafter reattaching said cap,
(c) repeating step (b) until substantially all the product of the container has been removed from the container, and
(d) discarding the container and saving the cap with the attached figurine.

21. The merchandising method of claim 20 where the figurine is one of a series of figurines all having a common theme and a plurality of said containers are sold with different figurines, but each figurine conforming to the common theme.

22. The merchandising method of claim 21 where the common theme comprises related cartoon characters.

23. The merchandising method of claim 21 where the common theme comprises animals.

24. The merchandising method of claim 21 where the common theme comprises plants.

25. The merchandising method of claim 21 where the common theme comprises athletes.

26. The merchandising method of claim 21 where the common theme comprises entertainers.

27. A merchandising method comprising
(a) providing individual containers holding the same product, said product being adapted to be removed from the container through a port therein,
(b) covering the port of each individual container with a removable cap with a figurine attached to the cap, said cap serving as a stand for the figurine upon removal of the cap, said figurine being one of a series of different figurines all having a common theme,
(c) distributing a plurality of said containers with different figurines attached to the caps thereof, each said figurine conforming to said common theme.

28. The merchandising method of claim 27 where the common theme comprises cartoon characters.

29. The merchandising method of claim 27 where the common theme comprises animals.

30. The merchandising method of claim 27 where the common theme comprises plants.

31. The merchandising method of claim 27 where the common theme comprises athletes.

32. The merchandising method of claim 27 where the common theme comprises entertainers.
